(19) United States
(12) Patent Application Publication
(10) Pub. No.: US 2022/0130312 A1
(43) Pub. Date: Apr. 28, 2022

(54) MULTI-DISPLAY DEVICE, DISPLAY DEVICE, METHOD FOR CONTROLLING MULTI-DISPLAY DEVICE, AND METHOD FOR CONTROLLING DISPLAY DEVICE

(71) Applicant: Sharp NEC Display Solutions, Ltd., Tokyo (JP)

(72) Inventor: Shinya NIIOKA, Tokyo (JP)

(21) Appl. No.: 17/572,116

(22) Filed: Jan. 10, 2022

Related U.S. Application Data
(63) Continuation of application No. PCT/JP2019/027458, filed on Jul. 11, 2019.

(51) Int. Cl. G09G 3/20

(52) U.S. Cl. CPC G09G 3/20; G09G 2354/00; G09G 2300/026; G09G 2310/0283

(57) ABSTRACT

A multi-display device has a plurality of display devices are arranged in a matrix shape. Each of the display devices includes: a scanning signal line drive circuit configured to switch a scanning direction of scanning signal lines of the corresponding display device between upward and downward for each row according to a position at which the corresponding display device is disposed; and a control unit configured to control the scanning signal line drive circuit such that one of the upward and downward directions of the scanning direction is selected as a first direction and the scanning signal lines are sequentially driven in the selected first direction and to control the scanning signal line drive circuit such that a second direction which is opposite to the selected first direction is selected and the scanning signal lines are sequentially driven in the selected second direction whenever a predetermined period elapses.

### TECHNICAL FIELD

The present invention relates to a multi-display device, a display device, a method for controlling a multi-display device, and a method for controlling a display device.

### BACKGROUND ART

In a multi-display device, in order to display an image on a plurality of display devices, it is important to resolve an image mismatch (a break in an image) between vertical joints of a plurality of display devices (display panels). For example, multi-display devices described in Patent Literature 1 and Patent Literature 2 are provided with a function that enables setting a scanning direction of gate scanning to be alternately inverted in a column direction of display devices according to arrangement of the display devices.

As a gate scanning circuit mounted in a display device (display panel), a built-in gate scanning circuit (a monolithic gate driver) that is integrally formed with a thin film transistor (TFT) on a glass substrate is practically used for the purpose of a decrease of the number of components or a decrease in bezel width. For example, Patent Literature 3 and Non Patent Literature 1 propose a bidirectional gate scanning circuit in which a scanning direction can be switched in a gate scanning circuit including a single conductivity type TFT.

### CITATION LIST

### Patent Literature

### [Patent Literature 1]

Japanese Unexamined Patent Application, First Publication No. 2006-330329

### [Patent Literature 2]

Japanese Unexamined Patent Application, First Publication No. 2013-117601

### [Patent Literature 3]

United States Patent Application, Publication No. 2012/0269316

### Non Patent Literature

### [Non Patent Literature 1]

“Late-News Paper: A Novel High Reliable Integrated Gate Driver with Bi-Scanning Structure using a-Si TFT for Large Size FHD TFT-LCD TVs” SID Digest, pp. 35-38, 2010

### SUMMARY OF INVENTION

### Technical Problem

However, in such a bidirectional gate scanning circuit including a single conductivity type TFT, when the gate scanning circuit is driven with a simple power supply configuration, there is a problem in that a TFT characteristic change progresses when the gate scanning circuit is used continuously for a long time in only one gate scanning direction and a defect in a display image may occur when a user switches the gate scanning direction.

The present invention was made in consideration of the aforementioned circumstances and an objective thereof is to provide a multi-display device, a display device, a method for controlling a multi-display device, and a method for controlling a display device that can curb progress of a TFT characteristic change in a bidirectional gate scanning circuit and improve operation reliability of a gate scanning inverting function.

### Solution to Problem

In order to achieve the aforementioned objective, according to an aspect of the invention, there is provided a multi-display device in which a plurality of display devices are arranged in a matrix shape, wherein each of the display devices includes: a scanning signal line drive circuit configured to switch a scanning direction of scanning signal lines of the corresponding display device between upward and downward for each row according to a position at which the corresponding display device is disposed; and a control unit configured to control the scanning signal line drive circuit such that one of the upward and downward directions of the scanning direction is selected as a first direction and the scanning signal lines are sequentially driven in the selected first direction and to control the scanning signal line drive circuit such that a second direction which is opposite to the selected first direction is selected and the scanning signal lines are sequentially driven in the selected second direction whenever a predetermined period elapses.

According to another aspect of the invention, there is provided a display device that is disposed in a multi-display device in which a plurality of display devices are arranged in a matrix shape, the display device including: a scanning signal line drive circuit configured to switch a scanning direction of scanning signal lines of the display device between upward and downward for each row according to a position at which the display device is disposed; and a control unit configured to control the scanning signal line drive circuit such that one of the upward and downward directions of the scanning direction is selected as a first direction and the scanning signal lines are sequentially driven in the selected first direction and to control the scanning signal line drive circuit such that a second direction which is opposite to the selected first direction is selected and the scanning signal lines are sequentially driven in the selected second direction whenever a predetermined period elapses.

According to another aspect of the invention, there is provided a method for controlling a multi-display device in which a plurality of display devices are arranged in a matrix shape, the method being performed by each of the display devices, the method including: a switching step of causing a scanning signal line drive circuit to switch a scanning direction of scanning signal lines of the corresponding display device between upward and downward for each row according to a position at which the corresponding display device is disposed; and a driving step of causing a control unit to control the scanning signal line drive circuit such that one of the upward and downward directions of the scanning direction is selected as a first direction and the scanning signal lines are sequentially driven in the selected first direction and to control the scanning signal line drive circuit such that a second direction which is opposite to the selected first direction is selected and the scanning signal lines are sequentially driven in the selected second direction whenever a predetermined period elapses.

According to another aspect of the invention, there is provided a method for controlling a display device that is disposed in a multi-display device in which a plurality of display devices are arranged in a matrix shape, the method including: a switching step of causing a scanning signal line drive circuit to switch a scanning direction of scanning signal lines of the display device between upward and downward for each row according to a position at which the display device is disposed; and a driving step of causing a control unit to control the scanning signal line drive circuit such that one of the upward and downward directions of the scanning direction is selected as a first direction and the scanning signal lines are sequentially driven in the selected first direction and to control the scanning signal line drive circuit such that a second direction which is opposite to the selected first direction is selected and the scanning signal lines are sequentially driven in the selected second direction whenever a predetermined period elapses.

### Advantageous Effects of Invention

According to the aspects of the invention, it is possible to curb progress of a TFT characteristic change in a bidirectional gate scanning circuit and to improve operation reliability of a gate scanning inverting function.

### BRIEF DESCRIPTION OF DRAWINGS

FIG. 1 is a block diagram illustrating an example of a configuration of a multi-display device 100 according to an embodiment of the invention.

FIG. 2A is a diagram illustrating a bidirectional gate scanning circuit according to the embodiment of the invention.

FIG. 2B is a diagram illustrating a bidirectional gate scanning circuit according to the embodiment of the invention.

FIG. 2C is a diagram illustrating a bidirectional gate scanning circuit according to the embodiment of the invention.

FIG. 2D is a diagram illustrating a bidirectional gate scanning circuit according to the embodiment of the invention.

FIG. 2E is a diagram illustrating a bidirectional gate scanning circuit according to the embodiment of the invention.

FIG. 3 is a block diagram illustrating an example of a configuration of a multi-display device 100 according to a first embodiment of the invention.

FIG. 4 is a block diagram illustrating an example of a configuration of a display device Di according to the first embodiment of the invention.

FIG. 5 is a flowchart illustrating a control method for the multi-display device 100 according to the first embodiment of the invention.

FIG. 6 is a diagram schematically illustrating a scanning direction of the multi-display device 100 according to the first embodiment of the invention.

FIG. 7 is a block diagram illustrating an example of a configuration of a multi-display device 100a according to a second embodiment of the invention.

FIG. 8 is a block diagram illustrating an example of a configuration of a display device Di in a multi-display device 100b according to a third embodiment of the invention.

FIG. 9 is a diagram illustrating a minimum configuration of a multi-display device 100 according to an embodiment of the invention.

### DESCRIPTION OF EMBODIMENTS

### First Embodiment

### Means of Solving Problems

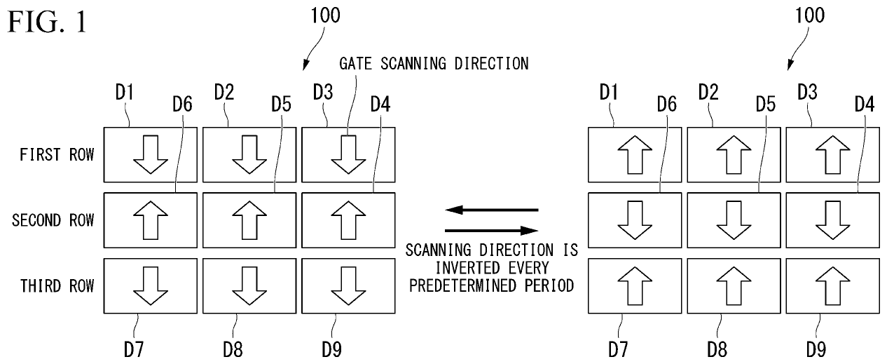

FIG. 1 is a block diagram illustrating an example of a configuration of a multi-display device 100 according to an embodiment of the invention.

As illustrated in FIG. 1, the multi-display device 100 is a multi-display device in which nine display devices M1 to M9 (a plurality of display devices) are arranged in a matrix shape (3 rows×3 columns).

Each of the display devices M1 to M9 includes a scanning signal line drive circuit (a gate scanning circuit that is not illustrated in FIG. 1 and can switch a “gate scanning direction”) that switches a gate scanning direction (a scanning direction of scanning signal lines) of the corresponding display device between upward and downward for each row according to a position at which the corresponding display device Mi (where i=1 to 9) is disposed.

As illustrated in the left part of FIG. 1, the gate scanning directions of a display device M1 disposed in a first row and a first column, a display device M2 disposed in the first row and a second column, a display device M3 disposed in the first row and a third column, a display device M7 disposed in a third row and the first column, a display device M8 disposed in the third row and the second column, and a display device M9 disposed in the third row and the third column are downward. On the other hand, the gate scanning directions of a display device M4 disposed in a second row and the third column, a display device M5 disposed in the second row and the second column, and a display device M6 disposed in the second row and the first column are upward.

That is, the scanning signal line drive circuit switches the scanning direction of the scanning signal lines of the display device between upward and downward for each row.

A control unit that is provided in each of the display devices M1 to M9 selects one of the upward and downward directions of the scanning direction and controls the scanning signal line drive circuit that is provided in each of the display devices M1 to M9 such that the scanning signal lines are sequentially driven in the selected first direction.

That is, as illustrated in the left part of FIG. 1, the control unit of each of the display devices M1 to M9 selects the gate scanning direction (the scanning direction of the scanning signal lines) according to the position at which the display device Mi (where i=1 to 9) is disposed and controls the scanning signal line drive circuit such that the scanning signal lines are sequentially driven in the selected first direction.

That is, the control unit of each of the display devices M1 to M3 and M7 to M9 selects the downward direction (one of the upward and downward directions of the scanning direction) and controls the scanning signal line drive circuit such that the scanning signal lines are sequentially driven in the selected downward direction.

On the other hand, the control unit of each of the display devices M4 to M6 selects the upward direction (one of the upward and downward directions of the scanning direction) and controls the scanning signal line drive circuit such that the scanning signal lines are sequentially driven in the selected upward direction.

Whenever a predetermined period elapses, the control unit of each of the display devices M1 to M9 controls the scanning signal line drive circuit such that a second direction which is opposite to the selected first direction is selected and the scanning signal lines are sequentially driven in the selected second direction.

That is, as illustrated in the right part of FIG. 1, the control unit of each of the display devices M1 to M9 inverts the gate scanning direction of the corresponding display device every predetermined period.

That is, whenever the predetermined time elapses, the control unit of each of the display devices M1 to M3 and M7 to M9 selects the upward direction which is opposite to the selected direction and controls the scanning signal line drive circuit such that the scanning signal lines are sequentially driven in the selected upward direction.

On the other hand, whenever the predetermined period elapses, the control unit of each of the display devices M4 to M6 selects the downward direction which is opposite to the selected direction and controls the scanning signal line drive circuit such that the scanning signal lines are sequentially driven in the selected downward direction.

### Detailed Description of Problems, Mechanism

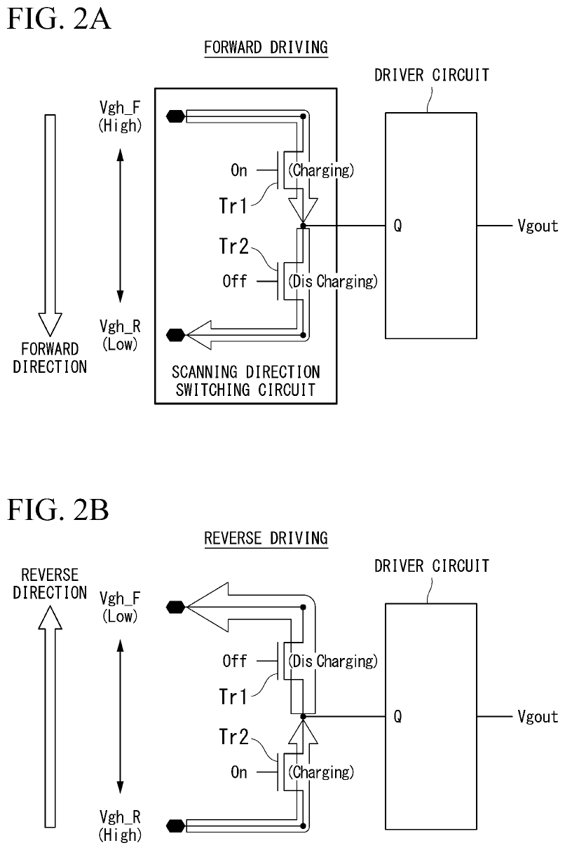

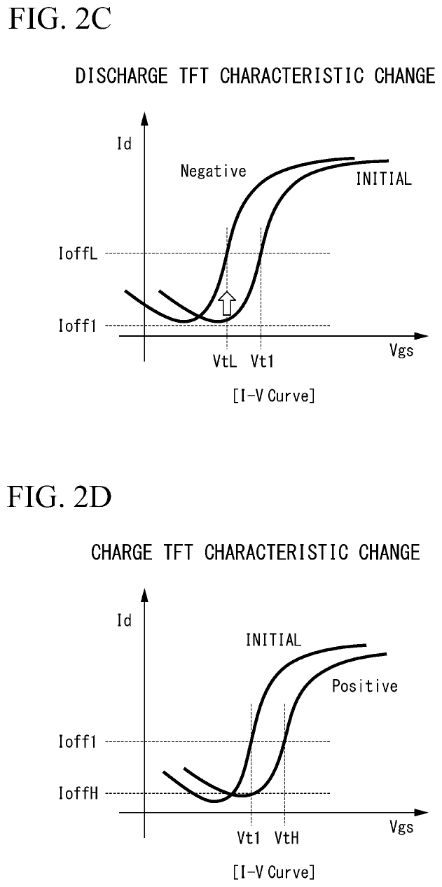

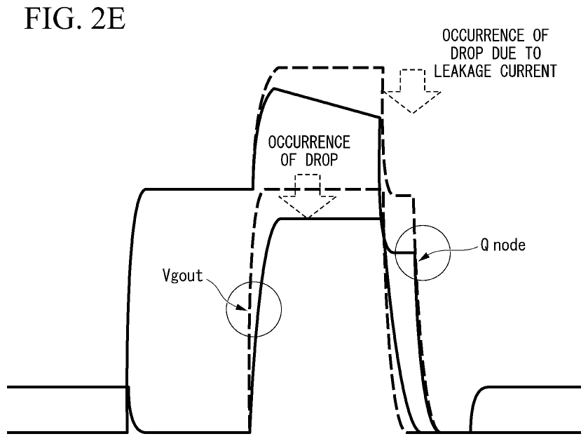

A bidirectional gate scanning circuit (a scanning signal line drive circuit) according to an embodiment of the invention will be described below with reference to FIGS. 2A, 2B, 2C, 2D, and 2E. FIGS. 2A, 2B, 2C, 2D, and 2E are diagrams illustrating a bidirectional gate scanning circuit according to an embodiment of the invention.

FIG. 2A is a diagram illustrating an operation of the bidirectional gate scanning circuit when it is forward-driven (switched and driven in the forward direction).

FIG. 2B is a diagram illustrating an operation of the bidirectional gate scanning circuit when it is reverse-driven (switched and driven in the reverse direction).

FIG. 2C is a diagram illustrating changes in characteristics of a transistor Tr2 when the bidirectional gate scanning circuit illustrated in FIG. 2A is forward-driven (switched and driven in the forward direction) or changes in characteristics of a transistor Tr1 when the bidirectional gate scanning circuit illustrated in FIG. 2B is reverse-driven (switched and driven in the reverse direction).

FIG. 2D is a diagram illustrating changes in characteristics of the transistor Tr1 when the bidirectional gate scanning circuit illustrated in FIG. 2A is forward-driven (switched and driven in the forward direction) or changes in characteristics of the transistor Tr2 when the bidirectional gate scanning circuit illustrated in FIG. 2B is reverse-driven (switched and driven in the reverse direction).

FIG. 2E is a diagram illustrating changes in Qnode and Vgout with the progress of the changes in characteristics of the transistor Tr2 when the bidirectional gate scanning circuit illustrated in FIG. 2A is forward-driven (switched and driven in the forward direction).

As illustrated in FIGS. 2A and 2B, the bidirectional gate scanning circuit that outputs a signal Vgout (a scanning signal) for supplying a voltage to one scanning signal line includes a transistor Tr1 formed of a single conductivity type TFT, a transistor Tr2 formed of a single conductivity type TFT, and a driver circuit including a transistor formed of a single conductivity type TFT.

Here, a single conductivity type thin film transistor (TFT) is a TFT having a single conductivity which is one of an N-channel TFT and a P-channel TFT and has the same conductivity type (for example, an N-channel type) as the single conductivity type TFT constituting a display pixel connected to the scanning signal line.

That is, as illustrated in FIGS. 2A and 2B, the bidirectional gate scanning circuit (scanning signal line drive circuit) includes a scanning direction switching circuit (the first transistor Tr1 and the second transistor Tr2) and the driver circuit when one of the upward and downward directions of the scanning direction selected by the control unit is defined as a forward direction and the other is defined as a reverse direction.

The first transistor Tr1 is formed of a single conductivity type TFT in which an output of a previous scanning signal line drive circuit in the forward direction is input to a gate and an output of a subsequent scanning signal line drive circuit in the reverse direction is input to the gate.

The second transistor Tr2 is formed of a single conductivity type TFT in which an output of a subsequent scanning signal line drive circuit in the forward direction is input to a gate and an output of a previous scanning signal line drive circuit in the reverse direction is input to the gate.

The driver circuit is formed of a single conductivity type TFT that supplies a voltage to the corresponding scanning signal line on the basis of a voltage of a node Q in which the source terminal of the first transistor Tr1 and the drain terminal of the second transistor Tr2 are connected.

With this configuration, as indicated by a solid line in FIGS. 2A and 2E, when the forward direction is selected in the bidirectional gate scanning circuit (scanning signal line drive circuit), the drain terminal of the first transistor Tr1 is supplied with a high voltage (Vgh_F(High)), the source terminal of the second transistor Tr2 is supplied with a low voltage (Vgh_R(Low)), a stepped-up voltage higher than the high voltage is generated in the node Q (Qnode), and the gate terminal of the single conductivity type TFT constituting a display pixel connected to the scanning signal line is supplied with a scanning signal (Vgout) with a high voltage via the scanning signal line.

On the other hand, as illustrated in FIG. 2B, when the reverse direction is selected in the bidirectional gate scanning circuit (scanning signal line drive circuit), the drain terminal of the first transistor Tr1 is supplied with a low voltage (Vgh_R(Low)), the source terminal of the second transistor Tr2 is supplied with a high voltage (Vgh_F(High)), a stepped-up voltage higher than the high voltage is generated in the node Q, and the gate terminal of the single conductivity type TFT constituting a display pixel connected to the scanning signal line is supplied with a scanning signal (Vgout) with a high voltage via the scanning signal line.

However, in the bidirectional gate scanning circuit including the single conductivity type TFTs, it has been seen that, when the gate scanning circuit is driven with a simple power supply configuration and is used continuously for a long time in only one gate scanning direction, changes in characteristics of the TFTs progress and a defect in a display image occurs when a user switches the gate scanning direction.

This will be appropriately described below with reference to FIGS. 2A to 2E.

The bidirectional gate scanning circuit includes a discharge TFT (the transistor Tr2 illustrated in FIG. 2A and the transistor Tr1 illustrated in FIG. 2B) and a charge TFT (the transistor Tr1 illustrated in FIG. 2A and the transistor Tr2 illustrated in FIG. 2B) in a scanning direction switching circuit which is a circuit unit for switching the scanning direction.

When it is continuously driven in only one gate scanning direction, a voltage stress is biased and a Vth shift of a TFT progresses irreversibly.

For example, as illustrated in FIG. 2C, in the discharge TFT (the transistor Tr2 illustrated in FIG. 2A and the transistor Tr1 illustrated in FIG. 2B), Vth shifts from Vt1 in an initial state to VtL in a negative state in a minus direction.

As illustrated in FIG. 2D, in the charge TFT (the transistor Tr1 illustrated in FIG. 2A and the transistor Tr2 illustrated in FIG. 2B), Vth shifts from Vt1 in an initial state to VtH in a positive state in a plus direction.

When Vth shifts in the minus direction, a TFT off leakage current increases. That is, as illustrated in FIG. 2C, for example, when a TFT off leakage current Ioff for Vgs=VtL is defined as Ioff1 in the initial state and IoffL in the positive state, the TFT off leakage current increases in the positive state.

As a result, when a user inverts the gate scanning direction, voltage-load states of the discharge TFT and the charge TFT are interchanged, that is, a drop occurs in the node Q (Qnod) as indicated by a dotted line in FIG. 2E. Accordingly, a gate voltage output (an output voltage Vgout) decreases due to an increase of the TFT off leakage current and a display defect occurs.

Therefore, by inverting the scanning direction every predetermined period in the bidirectional gate scanning circuit, progress of the TFT characteristic changes is curbed and a leakage current that occurs when the gate scanning direction is inverted is decreased. Accordingly, it is possible to improve operation reliability of a gate scanning inverting function.

By inverting the gate scanning direction every predetermined period in the bidirectional gate scanning circuit, voltage-load environments of the TFTs (the charge TFT and the discharge TFT) in a circuit for switching to two directions are interchanged and the TFT characteristic changes over long-term use are averaged. Since the TFT characteristic changes (the Vth shift directions) are cancelled out, it is possible to improve lifespan reliability of a circuit operation.

### Structure of First Embodiment

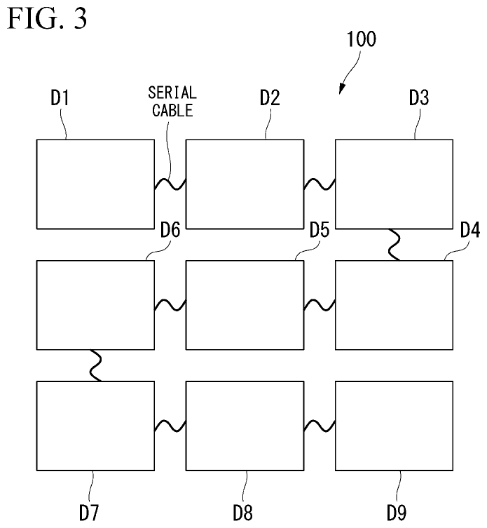

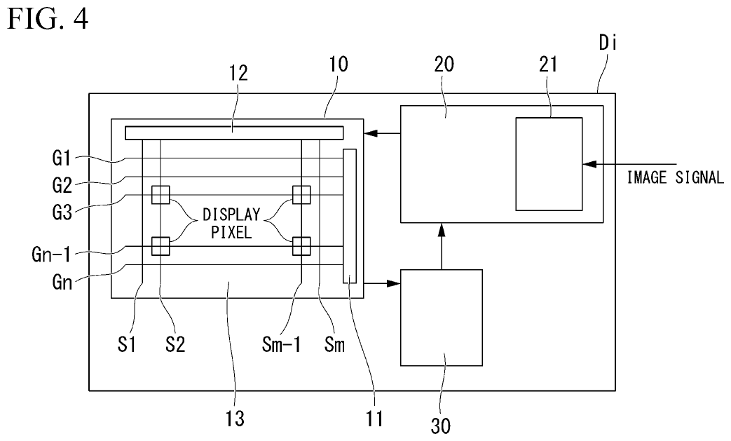

A structure of the multi-display device 100 and a structure of the display device Di according to this embodiment will be described below with reference to FIGS. 3 and 4.

FIG. 3 is a block diagram illustrating an example of a configuration of the multi-display device 100 according to an embodiment of the invention. FIG. 4 is a block diagram illustrating an example of a configuration of a display device Di according to an embodiment of the invention.

As illustrated in FIG. 3, the multi-display device 100 is configured as a display system that can display an image using the display devices Di as one screen by arranging the display devices Di in 3 (row direction, horizontal direction=M)×3 (column direction, vertical direction=N). In the multi-display device 100, a plurality of display devices Di (where i=3×3) are connected in a daisy-chain manner and are connected, for example, by a route R which is a serial cable.

Here, when a display unit 10 constituting each display device Di includes display pixels of m in the row direction (horizontal direction)×n in the column direction (vertical direction) as illustrated in FIG. 4, the multi-display device 100 can display an image corresponding to an image signal which can be displayed by mM in the row direction (horizontal direction)×nN in the column direction (vertical direction) by causing the display device Di to display a divided image corresponding to an image signal (a divided image signal) expressed in m×n.

Accordingly, the display device D1 is connected to a multi-display control device which is not illustrated in FIG. 3.

The multi-display control device outputs nine (=M×N) divided image signals in m×n to the route R.

The multi-display control device outputs display device IDs (X, Y) indicating what divided image out of the divided images corresponding to the nine (=M×N) divided image signals the display device Di displays to the route R. Here, in a display device ID (X, Y), X indicates a column number of the corresponding display device ID assigned in the row direction and Y indicates a row number of the corresponding display device ID assigned in the column direction. As described above, the control unit 20 in the display device Di controls a bidirectional gate scanning circuit 11 such that the scanning direction of the scanning signal lines of the display device Di is switched between upward and downward for each row according to a position at which the display device Di is disposed (according to the value of Y).

As will be described later, the multi-display control device outputs a synchronization signal (a vertical synchronization signal and a horizontal synchronization signal), which is used when the control unit 20 of the display device Di controls the bidirectional gate scanning circuit 11 and a data driver circuit 12 (a data signal line drive circuit) such that the scanning signal is output to the scanning signal lines and data signals are output to the data signal lines, to the route R.

As illustrated in FIG. 4, the display device Di includes a display unit 10, a control unit 20, and a cumulative time calculating unit 30.

The display unit 10 includes the bidirectional gate scanning circuit 11, the data driver circuit 12, and a display panel 13.

The bidirectional gate scanning circuit 11 sequentially outputs scanning signals Gout1 to Goutn to n scanning signal lines G1 to Gn extending in the horizontal direction.

Here, When the control unit 20 selects the downward direction (the order from the scanning signal line G1 to the scanning signal line Gn in FIG. 4) out of the upward and downward directions as the gate scanning direction of the bidirectional gate scanning circuit 11 as described above in [Detailed description of problems, mechanism], this operation is defined as forward selection. On the other hand, when the control unit 20 selects the upward direction (the order from the scanning signal line Gn to the scanning signal line G1 in FIG. 4), this operation is defined as reverse selection.

The bidirectional gate scanning circuit 11 selects one of the n scanning signal lines extending in the horizontal direction (a lateral direction in the drawing) in response to a selection instruction from the control unit 20, selects N-channel TFTs of m display pixels by supplying a scanning signal of a H level to the selected scanning signal line, and connects pixel electrodes of the m display pixels to m data signal lines S1 to Sm.

The data driver circuit 12 selects all the m data signal lines Si to Sm extending in the vertical direction (a longitudinal direction in the drawing) in response to a selection instruction from the control unit 20, supplies levels corresponding to the image signal to the m data signal lines S1 to Sm, and supplies voltages of the pixel electrodes of the m display pixels via the m N-channel TFTs selected by the bidirectional gate scanning circuit 11.

The display panel 13 is, for example, a liquid crystal panel and includes a plurality of (m in the horizontal direction and n in the vertical direction) display pixels of which each includes a scanning signal line, an N-channel TFT that is turned on/off according to a scanning signal supplied to the scanning signal line, a pixel electrode that is connected to one end of the N-channel TFT, and a data signal line that is connected to the other end of the N-channel TFT.

The control unit 20 includes a memory 21.

The memory 21 temporarily stores an image signal input from the outside. Here, the divided image signals, the display device IDs (X, Y), and the input image synchronization signal (a vertical synchronization signal Vsync and a horizontal synchronization signal Hsync) are input as the image signal which is input to the display device Di via the route R to the memory 21, and the image signal is stored.

It is assumed that an image data transmission period corresponding to one frame of a divided image signal corresponds to one vertical period defined by the vertical synchronization signal Vsync.

Driving of the display panel 13 by the control unit 20 will be described below.

The control unit 20 generates a horizontal synchronization control signal and a vertical synchronization control signal as an image synchronization signal serving as a reference for allowing the circuits (the bidirectional gate scanning circuit 11 and the data driver circuit 12) to operate in synchronization on the basis of the input image synchronization signal input to the memory 21. For example, the control unit 20 generates a vertical synchronization control signal with the same period as the input vertical synchronization signal Vsync and generates a horizontal synchronization control signal with the same period as the input horizontal synchronization signal Hsync. The control unit 20 outputs the generated horizontal synchronization control signal and the generated vertical synchronization control signal as an image synchronization signal to the bidirectional gate scanning circuit 11 and the data driver circuit 12.

In the display unit 10, the vertical synchronization control signal is input every vertical period. First, the control unit 20 changes a voltage of a control signal for activating an analog amplifier of the data driver circuit 12, for example, from a L (low) level to a H (high) level in synchronization with the vertical synchronization control signal. Accordingly, the analog amplifier of the data driver circuit 12 is switched from a deactivated state to an activated state.

Then, the bidirectional gate scanning circuit 11 outputs a gate clock signal (a scanning signal) to the first scanning signal line G1 or Gn in synchronization with the vertical synchronization control signal and the horizontal synchronization signal. Accordingly, the gate of the N-channel TFT of the display pixel connected to the scanning signal line G1 or Gn is turned on.

Then, the data driver circuit 12 outputs a data signal from the analog amplifier connected to the corresponding data signal line S for each data signal line S in synchronization with the horizontal synchronization control signal. Accordingly, voltages required for display are supplied to the data signal lines Si to Sm and are written to the pixel electrodes on the scanning signal line G1 or Gn via the N-channel TFTs. After the writing has ended, the gates of the N-channel TFTs of the display pixels connected to the scanning signal line G1 or Gn are returned from an ON state to an OFF state.

When a first one horizontal period elapses, a next horizontal synchronization control signal is input. Pixels connected to the second scanning signal line G2 or Gn-1 are subjected to writing in the same order as the pixels connected to the first scanning signal line G1 or Gn. In this way, writing is performed on each of all the n scanning signal lines G1 to Gn. The writing period is the same as the scanning period.

The control signal for activating the analog amplifier of the data driver circuit 12 is held at the H level in the writing period. When the writing period (scanning period) has elapsed in the first one vertical period, the control unit 20 changes the control signal for activating the analog amplifier of the data driver circuit 12 from the H level to the L level. As a result, the analog amplifier of the data driver circuit 12 is changed to the deactivated state.

When a first one vertical period elapses, a next vertical synchronization control signal is input, and driving for the second or subsequent frame is performed in the same sequence as described above.

Here, the bidirectional gate scanning circuit 11 outputs the gate clock signal (scanning signal) to the first scanning signal line G1 or Gn, but to which scanning signal line out of the scanning signal lines G1 and Gn the gate clock signal is to be output is determined by causing the control unit 20 to select whether the gate scanning direction of the bidirectional gate scanning circuit 11 is set to a forward direction or a reverse direction. That is, the control unit 20 controls the gate scanning direction.

That is, as illustrated in FIG. 4, the forward selection is performed when the gate clock signal Vgout1 (scanning signal) is output to the first scanning signal line G1, and the reverse selection is performed when the gate clock signal Vgoutn (scanning signal) is output to the first scanning signal line Gn.

The control unit 20 can detect position information of a display device Di, and can select the gate scanning direction on the basis of the position information of the display device Di.

That is, the control unit 20 reads a display device ID (X, Y) from the memory 21 and sets the scanning direction to the forward direction when the value Y of the display device Di is 1 or 3 (an odd number), that is, when the display device Di is D1, D2, D3, D7, D8, or D9, for example, as illustrated in the multi-display device 100 in the left part of FIG. 1. On the other hand, when the value Y is 2 (an even number), that is, when the display device Di is D4, D5, or D6, the control unit 20 sets the scanning direction to the reverse direction, for example, as illustrated in the multi-display device 100 in the left part of FIG. 1.

On the other hand, when the value Y of the display device Di is 1 or 3 (an odd number), that is, when the display device Di is D1, D2, D3, D7, D8, or D9, the scanning direction may be set to the reverse direction, for example, as illustrated in the multi-display device 100 in the right part of FIG. 1. On the other hand, when the value Y is 2 (an even number), that is, when the display device Di is D4, D5, or D6, the scanning direction may be set to the forward direction, for example, as illustrated in the multi-display device 100 in the left part of FIG. 1.

When the gate scanning direction is inverted, the image signal stored in the memory is inverted and output to the display panel.

That is, when the forward direction is selected, the control unit 20 controls the data driver circuit 12 such that the data signals corresponding to the order in the forward direction of the scanning signal lines in the data signals (the data signals corresponding to the scanning signal lines G1 to Gn) are supplied to the data signal lines in the order in the forward direction in the data signals (in the order of the data signal corresponding to the scanning signal line G1, the data signal corresponding to the scanning signal line G2, . . . , and the data signal corresponding to the scanning signal line Gn).

On the other hand, when the reverse direction is selected, the control unit 20 controls the data driver circuit 12 such that the data signals corresponding to the order in the reverse direction of the scanning signal lines in the data signals (the data signals corresponding to the scanning signal lines G1 to Gn) are supplied to the data signal lines in the order in the reverse direction in the data signals (in the order of the data signal corresponding to the scanning signal line Gn, the data signal corresponding to the scanning signal line Gn-1, . . . , and the data signal corresponding to the scanning signal line G1).

That is, the control unit 20 controls the data driver circuit 12 such that the data signals corresponding to the order in the forward direction of the scanning signal lines in the data signals are supplied to the data signal lines in the order in the forward direction when the forward direction is selected, and controls the data driver circuit 12 such that the data signals corresponding to the order in the forward direction of the scanning signal lines in the data signals are supplied to the data signal lines in the order in the reverse direction when the reverse direction is selected.

### Determination of Predetermined Period in First Embodiment

The cumulative time calculating unit 30 counts a cumulative time in which the display unit 10 is used. Accordingly, the bidirectional gate scanning circuit 11 inverts the gate scanning direction every predetermined cumulative operating time on the basis of information of the cumulative time calculating unit 30 provided in the display device Di.

That is, the cumulative time calculating unit 30 calculates a cumulative display time after the bidirectional gate scanning circuit 11 has switched the scanning direction between upward and downward.

When the calculated cumulative display time becomes longer than a predetermined period, the control unit 20 controls the bidirectional gate scanning circuit 11 such that the second direction which is opposite to the selected first direction is selected and the scanning signal lines are sequentially driven in the selected second direction (in the order in the forward direction when the currently selected direction is the reverse direction or in the order in the reverse direction when the currently selected direction is the forward direction).

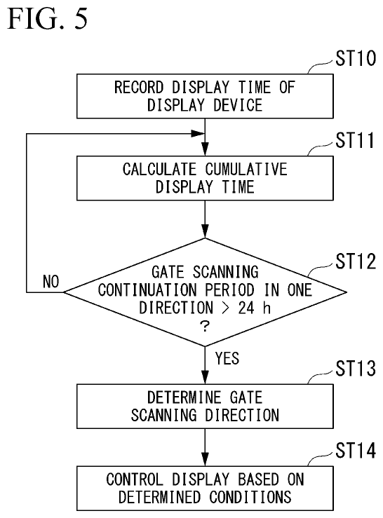

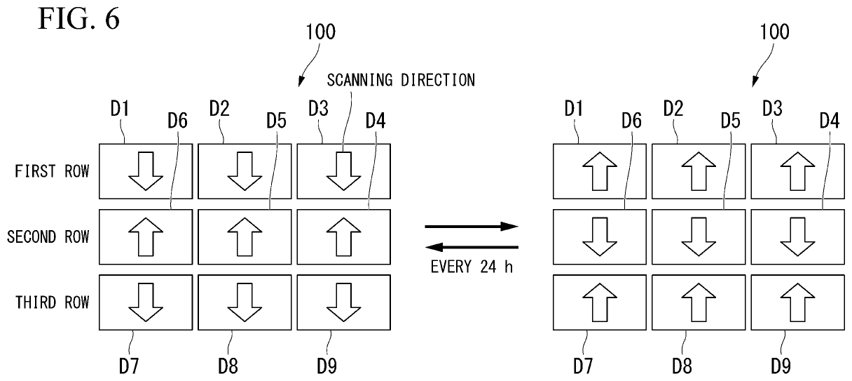

A control method which is performed by the control unit 20 and the cumulative time calculating unit 30 will be described below with reference to FIGS. 5 and 6. FIG. 5 is a flowchart illustrating a control method for the multi-display device 100 according to the first embodiment of the invention. FIG. 6 is a diagram schematically illustrating the scanning direction of the multi-display device 100 according to the first embodiment of the invention.

A display time of the display device is recorded (Step ST10).

Specifically, the cumulative time calculating unit 30 of each display device Di records the display time of the display panel 13 in the display unit 10.

A cumulative display time is calculated (Step ST11).

Specifically, the cumulative time calculating unit 30 of each display device Di calculates a cumulative display time after the bidirectional gate scanning circuit 11 has switched the scanning direction between upward and downward.

It is determined whether a gate scanning-based drive period in one direction is longer than 24 h (Step ST12).

Specifically, the control unit 20 of each display device Di determines whether the gate scanning-based drive period (the cumulative display time) in one direction is longer than 24 h (hours).

When the cumulative display time is equal to or shorter than 24 h (Step ST12: NO), the process routine returns to Step ST11. On the other hand, when the cumulative display time is longer than 24 h (the predetermined period) (Step ST12: YES), the process routine proceeds to Step ST13.

The gate scanning direction is determined (Step ST13).

Specifically, the control unit 20 of each display device Di determines that the scanning direction of the bidirectional gate scanning circuit 11 is the reverse direction when the current gate scanning direction is the forward direction and the forward direction when the current gate scanning direction is the reverse direction as illustrated in FIG. 6.

For example, as illustrated in FIG. 6, a period (the predetermined period) which is compared with the cumulative display time in Step ST12 is 24 h. This is because it is preferable that the gate scanning direction of the display device Di is inverted every 24 h in an environment of use of 24 h. The timing at which the gate scanning direction is inverted may be simultaneously switched according to an average value of the cumulative times when there is a difference in cumulative time between the display devices out of the display devices Di connected by a serial cable.

Display control is performed on the basis of the determined conditions (Step ST14).

Specifically, the control unit 20 of each display device Di performs the display control of the display panel 13 by performing control for switching the scanning direction of the bidirectional gate scanning circuit 11 to the scanning direction determined in Step ST13 and controlling the data driver circuit 12.

### Second Embodiment

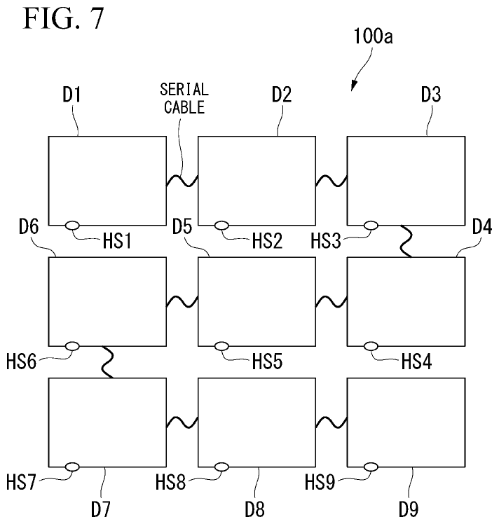

FIG. 7 is a block diagram illustrating an example of a configuration of a multi-display device 100a according to a second embodiment of the invention.

As illustrated in FIG. 7, each display device Di in the multi-display device 100a includes a motion sensor HSi. That is, when the control unit 20 determines that there is no viewer in any sensors of a plurality of display devices Di of the multi-display device 100a, the gate scanning direction in each display device Di is inverted.

That is, each of the plurality of display devices Di includes a motion sensor HSi. When all of the plurality of motion sensors HSi have determined that there is no viewer (the detection results from the plurality of motion sensors indicate that there is no viewer), the control unit 20 determines that a predetermined period has elapsed and controls the bidirectional gate scanning circuit (the scanning signal line drive circuit) such that the second direction which is opposite to the selected first direction is selected and the scanning signal lines are sequentially driven in the selected second direction.

In this way, by inverting the gate scanning direction in an environment in which there is no viewer, it is possible to effectively perform an inverting operation without giving discomfort in display to a viewer.

### Third Embodiment

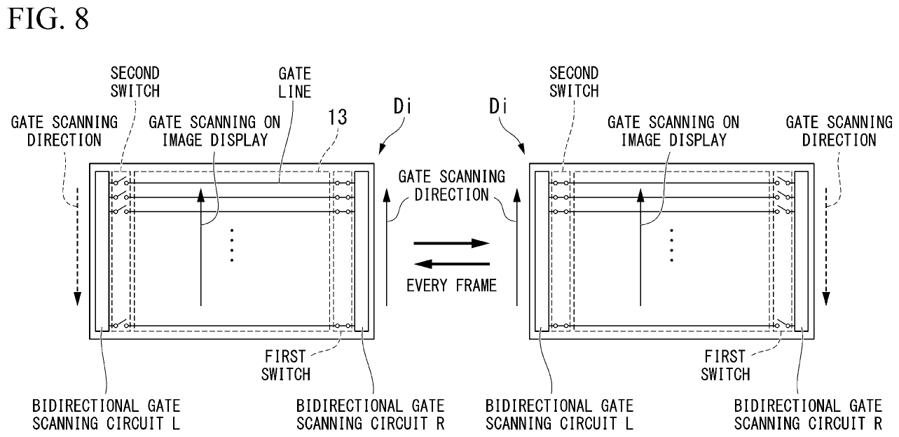

FIG. 8 is a block diagram illustrating an example of a configuration of a display device Di in a multi-display device 100b according to a third embodiment of the invention.

The display device Di includes a bidirectional gate scanning circuit L (a second scanning signal line drive circuit) and a bidirectional gate scanning circuit R (a first scanning signal line drive circuit) which are arranged in a direction perpendicular to the scanning direction of the scanning signal lines at right angle (at both ends of the display panel 13) outside of the gate lines (the scanning signal lines) of the display panel 13.

Each of the two bidirectional gate scanning circuits includes switches (a first switch or a second switch) that electrically separates an output of a gate electrode from the gate lines of the display panel 13.

As illustrated in the left part of FIG. 8, when the gate scanning circuit R is outputting and displaying an image while performing gate scanning in one direction (upward direction), the other gate scanning circuit L is electrically separated from the gate lines of the display panel 13 by the second switch and is controlled such that it is driven in the scanning direction (downward direction) opposite to the gate scanning circuit R.

That is, the display device Di includes the bidirectional gate scanning circuit R (the first scanning signal line drive circuit) and the bidirectional gate scanning circuit L (the second scanning signal line drive circuit) with the same configuration as the bidirectional gate scanning circuits (the scanning signal line drive circuits) disposed at both ends of the display panel 13. The display device Di includes the first switch and the second switch.

The first switch has a configuration in which an input terminal is connected to the bidirectional gate scanning circuit R and an output terminal is connected to the scanning signal lines G1 to Gn and connects the bidirectional gate scanning circuit R to the scanning signal lines G1 to Gn according to a first switch control signal output from the control unit 20.

The second switch has a configuration in which an input terminal is connected to the bidirectional gate scanning circuit L and an output terminal is connected to the scanning signal lines G1 to Gn and connects the bidirectional gate scanning circuit L to the scanning signal lines G1 to Gn according to a second switch control signal output from the control unit 20.

Depending on the position at which the display device Di is disposed, the control unit 20 turns on the first switch and controls the bidirectional gate scanning circuit R such that the input terminal of the first switch is sequentially driven in the selected one direction (upward), and turns off the second switch and controls the bidirectional gate scanning circuit L such that the input terminal of the second switch is sequentially driven in a direction (downward) opposite to the selected one direction (upward). Accordingly, the scanning signal lines G1 to Gn are driven by the bidirectional gate scanning circuit R.

Then, when it is determined that a period of one frame which is the predetermined period has elapsed, the control unit 20 turns off the first switch and controls the bidirectional gate scanning circuit R such that the input terminal of the first switch is sequentially driven in the direction (downward) opposite to the selected one direction (upward), and turns on the second switch and controls the bidirectional gate scanning circuit L such that the input terminal of the second switch is sequentially driven in the selected one direction (upward). Accordingly, the scanning signal lines G1 to Gn are driven by the bidirectional gate scanning circuit L.

In this way, since the gate scanning direction on a displayed image which is viewed by a viewer is not changed, it is possible to control inversion of the gate scanning circuit (the bidirectional gate scanning circuits R and L) every frame without giving discomfort to a viewer. Accordingly, it is possible to cancel out a TFT characteristic change in the bidirectional switching circuits (the scanning direction switching circuits of the bidirectional gate scanning circuits R and L) every frame and to improve long-term reliability of the gate scanning circuit.

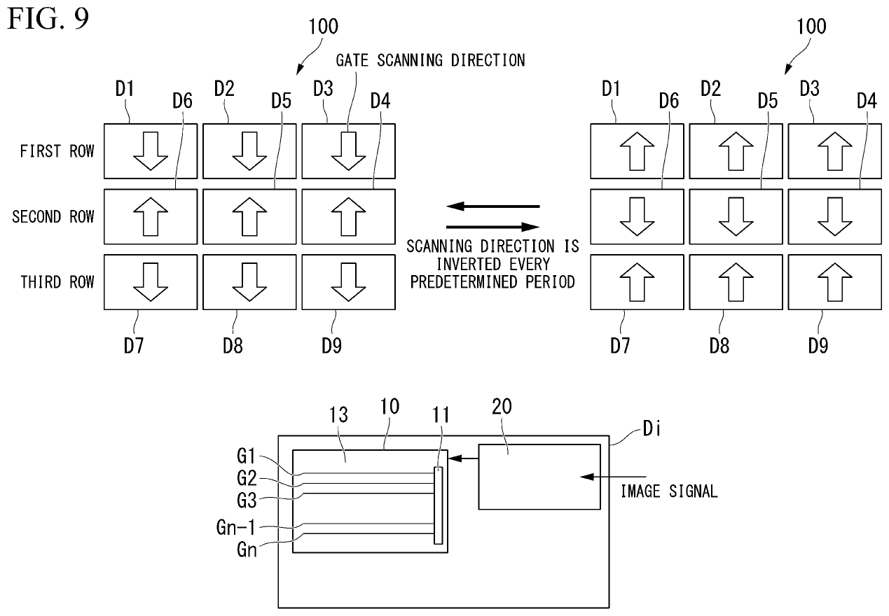

A minimum configuration of the aforementioned embodiments will be described below with reference to FIG. 9. FIG. 9 is a diagram illustrating a minimum configuration of a multi-display device 100 according to an embodiment of the invention.

The multi-display device 100 is a multi-display device in which a plurality of display devices Di (where i=1 to 9) are arranged in a matrix shape.

Each of the display devices Di includes a bidirectional gate scanning circuit 11 (a scanning signal line drive circuit) and a control unit 20.

The bidirectional gate scanning circuit 11 switches the scanning direction of the scanning signal lines of the display device Di between upward and downward for each row according to the position at which the display device Di is disposed.

For example, as illustrated as the multi-display device 100 in the left part of FIG. 9, the bidirectional gate scanning circuit 11 in each of the display devices D1, D2, D3, D7, D8, and D9 in the first row and the third row (Y=an odd number) sets the scanning direction of the scanning signal lines to the downward direction (forward direction). On the other hand, the bidirectional gate scanning circuit in each of the display devices D4, D5, and D6 in the second row (Y=an even number) sets the scanning direction of the scanning signal lines to the upward direction (reverse direction).

Accordingly, the control unit 20 selects one of the upward and downward directions of the scanning direction and controls the bidirectional gate scanning circuit 11 such that the scanning signal lines are sequentially driven in the selected first direction.

For example, as illustrated as the multi-display device 100 in the left part of FIG. 9, the control unit 20 in each of the display devices D1, D2, D3, D7, D8, and D9 in the first row and the third row (Y=an odd number) selects one (downward) of the upward and downward directions of the scanning direction and controls the bidirectional gate scanning circuit 11 such that the scanning signal lines are sequentially driven in the selected direction (downward). On the other hand, the control unit 20 in each of the display devices D4, D5, and D6 in the second row (Y=an even number) selects one (upward) of the upward and downward directions of the scanning direction and controls the bidirectional gate scanning circuit 11 such that the scanning signal lines are sequentially driven in the selected direction (upward).

Whenever a predetermined period elapses, the control unit 20 controls the bidirectional gate scanning circuit 11 such that a second direction opposite to the selected first direction is selected and the scanning signal lines are sequentially driven in the selected second direction.

For example, as illustrated as the multi-display device 100 in the right part of FIG. 9, the control unit 20 in each of the display devices D1, D2, D3, D7, D8, and D9 in the first row and the third row (Y=an odd number) controls the bidirectional gate scanning circuit 11 such that a reverse direction (upward) opposite to the selected direction (downward) is selected and the scanning signal lines are sequentially driven in the selected reverse direction (upward). On the other hand, the control unit 20 in each of the display devices D4, D5, and D6 in the second row (Y=an even number) controls the bidirectional gate scanning circuit 11 such that a reverse direction (downward) opposite to the selected direction (upward) is selected and the scanning signal lines are sequentially driven in the selected reverse direction (downward).

According to the embodiments of the invention or the example of the minimum configuration, it is possible to curb progress of a TFT characteristic change in the bidirectional gate scanning circuit and to improve operation reliability of a gate scanning inverting function.

While embodiments of the invention have been described above in detail with reference to the drawings, any specific configuration is not limited to the embodiments and includes a design or the like without departing from the gist of the invention.

For example, the display device is not limited to a liquid crystal display (LCD), and a display device employing a known display panel such as an organic EL display, an electrophoresis display, an MEMS display, a plasma display, or a hologram display can be used.

The same advantages as in the invention can be achieved as long as a known technique of a display in which a bidirectional gate scanning circuit formed of a single conductivity type TFT is mounted is used.

A partial or whole program which is executed by one or more computers such as a CPU according to the embodiments can be distributed via a communication line or a computer-readable recording medium.

### REFERENCE SIGNS LIST

10 . . . Display unit

R, L . . . Bidirectional gate scanning circuit

12 . . . Data driver circuit

13 . . . Display panel

20 . . . Control unit

21 . . . Memory

30 . . . Cumulative time calculating unit

D1, D2, D3, D4, D5, D6, D7, D8, D9, Di . . . Display device

G1, G2, Gn-1, Gn . . . Scanning signal line

D1, D2, Dm-1, Dm . . . Data signal line

HS1, HS2, HS3, HS4, HS5, HS6, HS7, HS8, HS9, HSi . . . Motion sensor

What is claimed is:

1. A multi-display device in which a plurality of display devices are arranged in a matrix shape,
wherein each of the display devices comprises:
a scanning signal line drive circuit configured to switch a scanning direction of scanning signal lines of the corresponding display device between upward and downward for each row according to a position at which the corresponding display device is disposed; and
a control unit configured to control the scanning signal line drive circuit such that one of the upward and downward directions of the scanning direction is selected as a first direction and the scanning signal lines are sequentially driven in the selected first direction and to control the scanning signal line drive circuit such that a second direction which is opposite to the selected first direction is selected and the scanning signal lines are sequentially driven in the selected second direction whenever a predetermined period elapses.

2. The multi-display device according to claim 1, wherein each of the plurality of display devices includes a motion sensor, and
wherein, when all results of detection from a plurality of motion sensors indicate that there are no viewers, the control unit determines that the predetermined period has elapsed and controls the scanning signal line drive circuit such that the second direction which is opposite to the selected first direction is selected and the scanning signal lines are sequentially driven in the selected second direction.

3. The multi-display device according to claim 1, wherein each of the display devices comprises:
a first scanning signal line drive circuit and a second scanning signal line drive circuit that have the same configuration as the scanning signal line drive circuit and that are disposed on both ends of a display panel;
a first switch of which an input terminal is connected to the first scanning signal line drive circuit, of which an output terminal is connected to the scanning signal lines, and which connects the first scanning signal line drive circuit and the scanning signal lines in response to a first switch control signal output from the control unit; and
a second switch of which an input terminal is connected to the second scanning signal line drive circuit, of which an output terminal is connected to the scanning signal lines, and which connects the second scanning signal line drive circuit and the scanning signal lines in response to a second switch control signal output from the control unit,
wherein, according to a position at which the corresponding display device is disposed, the control unit is configured to:
turn on the first switch and control the first scanning signal line drive circuit such that the input terminal of the first switch is sequentially driven in the selected first direction; and
turn off the second switch and control the second scanning signal line drive circuit such that the input terminal of the second switch is sequentially driven in the second direction which is opposite to the selected first direction, and
wherein, when it is determined that one frame period which is the predetermined period has elapsed, the control unit is configured to:
turn of the first switch and control the first scanning signal line drive circuit such that the input terminal of the first switch is sequentially driven in the second direction which is opposite to the selected first direction; and
turn on the second switch and control the second scanning signal line drive circuit such that the input terminal of the second switch is sequentially driven in the selected first direction.

4. The multi-display device according to claim 1, further comprising a cumulative time calculating unit configured to calculate a cumulative display time after the scanning signal line drive circuit has switched the scanning direction between upward and downward,
wherein the control unit is configured to control the scanning signal line drive circuit such that the second direction which is opposite to the selected first direction is selected and the scanning signal lines are sequentially driven in the selected second direction when the calculated cumulative display time is longer than the predetermined period.

5. The multi-display device according to claim 1, wherein the scanning signal line drive circuit includes: when one of the upward and downward directions of the scanning direction selected by the control unit is defined as a forward direction and the other is defined as a reverse direction,
a first transistor formed of a single conductivity type TFT in which an output of a previous scanning signal line drive circuit in the forward direction is input to a gate and an output of a subsequent scanning signal line drive circuit in the reverse direction is input to the gate;
a second transistor formed of a single conductivity type TFT in which an output of a subsequent scanning signal line drive circuit in the forward direction is input to a gate and an output of a previous scanning signal line drive circuit in the reverse direction is input to the gate; and
a driver circuit formed of a single conductivity type TFT that supplies a voltage to the scanning signal lines on the basis of a voltage of a node in which a source terminal of the first transistor and a drain terminal of the second transistor are connected,
wherein, when the forward direction is selected, a drain terminal of the first transistor is supplied with a high voltage, a source terminal of the second transistor is supplied with a low voltage, a stepped-up voltage higher than the high voltage is generated in the node, and a gate terminal of a single conductivity type TFT constituting a display pixel connected to the corresponding scanning signal line is supplied with the high voltage via the scanning signal line, and
wherein, when the reverse direction is selected, the drain terminal of the first transistor is supplied with the low voltage, the source terminal of the second transistor is supplied with the high voltage, a stepped-up voltage higher than the high voltage is generated in the node, and the gate terminal of the single conductivity type TFT constituting the display pixel connected to the corresponding scanning signal line is supplied with the high voltage via the scanning signal line.

6. The multi-display device according to claim 1, wherein each of the display devices includes:
a display panel in which a plurality of display pixels each including the corresponding scanning signal line, a transistor that is turned on/off in response to a scanning signal supplied to the scanning signal line, a pixel electrode that is connected to one end of the transistor, and a data signal line that is connected to the other end of the transistor are arranged in a horizontal direction and a vertical direction; and
a data signal line drive circuit that supplies data signals to the data signal lines, and
wherein the control unit is configured to control the scanning signal line drive circuit on the basis of a vertical synchronization signal and a horizontal synchronization signal which are input from the outside such that the scanning signal is supplied to the scanning signal lines and to control the data signal line drive circuit on the basis of the horizontal synchronization signal which is input from the outside such that the data signals are supplied to the data signal lines, and
wherein the plurality of display pixels are driven according to an image signal.

7. The multi-display device according to claim 6, wherein each of the display devices includes a memory that stores position information indicating the position at which the corresponding display device is disposed, a divided image signal based on the position at which the corresponding display device is disposed, the scanning signal corresponding to the divided image signal, the data signals corresponding to the divided image signal, the vertical synchronization signal, and the horizontal synchronization signal, and
wherein, when one of the upward and downward directions of the scanning direction selected by the control unit is defined as a forward direction and the other is defined as a reverse direction, the control unit is configured to:
control the data signal line drive circuit such that the data signals corresponding to the order in the forward direction of the scanning signal lines in the data signals are supplied to the data signal lines in the order in the forward direction when the forward direction is selected; and
control the data signal line drive circuit such that the data signals corresponding to the order in the forward direction of the scanning signal lines in the data signals are supplied to the data signal lines in the order in the reverse direction when the reverse direction is selected.

8. A display device that is disposed in a multi-display device in which a plurality of display devices are arranged in a matrix shape, the display device comprising:
a scanning signal line drive circuit configured to switch a scanning direction of scanning signal lines of the display device between upward and downward for each row according to a position at which the display device is disposed; and
a control unit configured to control the scanning signal line drive circuit such that one of the upward and downward directions of the scanning direction is selected as a first direction and the scanning signal lines are sequentially driven in the selected first direction and to control the scanning signal line drive circuit such that a second direction which is opposite to the selected first direction is selected and the scanning signal lines are sequentially driven in the selected second direction whenever a predetermined period elapses.

9. A method for controlling a multi-display device in which a plurality of display devices are arranged in a matrix shape, the method being performed by each of the display devices, the method comprising:
a switching step of causing a scanning signal line drive circuit to switch a scanning direction of scanning signal lines of the corresponding display device between upward and downward for each row according to a position at which the corresponding display device is disposed; and
a driving step of causing a control unit to control the scanning signal line drive circuit such that one of the upward and downward directions of the scanning direction is selected as a first direction and the scanning signal lines are sequentially driven in the selected first direction and to control the scanning signal line drive circuit such that a second direction which is opposite to the selected first direction is selected and the scanning signal lines are sequentially driven in the selected second direction whenever a predetermined period elapses.

10. A method for controlling a display device that is disposed in a multi-display device in which a plurality of display devices are arranged in a matrix shape, the method comprising:
a switching step of causing a scanning signal line drive circuit to switch a scanning direction of scanning signal lines of the display device between upward and downward for each row according to a position at which the display device is disposed; and
a driving step of causing a control unit to control the scanning signal line drive circuit such that one of the upward and downward directions of the scanning direction is selected as a first direction and the scanning signal lines are sequentially driven in the selected first direction and to control the scanning signal line drive circuit such that a second direction which is opposite to the selected first direction is selected and the scanning signal lines are sequentially driven in the selected second direction whenever a predetermined period elapses.
